(19) United States
(12) Patent Application Publication
(10) Pub. No.: US 2011/0217575 A1
(43) Pub. Date: Sep. 8, 2011

(54) Arrangement Of Stationary Batteries

(76) Inventors: Willy Hermansson, Vasteras (SE); Bertil Nygren, Vasteras (SE); Falah Hosini, Vasteras (SE); Fredrik Tinglow, Arboga (SE); Jan R. Svensson, Vasteras (SE)

(21) Appl. No.: 13/109,757

(22) Filed: May 17, 2011

Related U.S. Application Data
(63) Continuation of application No. PCT/EP2009/065226, filed on Nov. 16, 2009.
(60) Provisional application No. 61/115,210, filed on Nov. 17, 2008.

(51) Int. Cl. H01M 2/12; H01M 2/10; H01M 10/04

(52) U.S. Cl. 429/82; 429/99; 29/623.1

(57) ABSTRACT

A cassette for a battery stack, including a casing for a battery pack, which casing is made of a non-conducting material. The casing has a front side with an opening for receiving the battery pack. Preferably, the casing has a back side, opposite the front side, the back side being provided with electrical connections leading into the casing and arranged to connect to the poles of a battery pack when a battery pack is inserted into the casing through the front side. Arrangement of the cassettes is also provided, wherein the cassettes in the arrangement is placed in mechanical connection on top of each other.

### CROSS-REFERENCE TO RELATED APPLICATIONS

The present application is a continuation of pending International patent application PCT/EP2009/065226 filed on Nov. 16, 2009 which claims the benefit under 35 U.S.C. §119 (e) of U.S. Provisional Patent Application Ser. No. 61/115,210, filed on Nov. 17, 2008. The content of all prior applications is incorporated herein by reference.

### FIELD OF THE INVENTION

The present invention relates to arrangements of batteries, and in particular, arrangements of stationary high power batteries.

### BACKGROUND OF THE INVENTION

Stationary batteries can be used in compensation of VAr (Volt Ampere reactive). Such systems often have a large number of batteries as a power source. The terminals of the individual batteries are connected in parallel and serial connections to provide the needed voltage and energy.

These large capacity batteries have been placed in, for example, cabinets or the like to fulfil space requirements, provide adequate ventilation and allow easy inspection. To prevent fires and/or limit the spreading of fire the batteries can be placed in fire safe cells or racks, for example, made of aluminium.

The batteries also have to be accessible for maintenance and replacement. Moreover, such access has to be provided in a safe manner avoiding electrical shocks. For this purpose fire safe aluminium cabinets or racks have been provided with ground connections.

Moreover, when a large number of batteries are used to provide high voltage energy storage, the aluminium racks for the batteries in different voltage levels have been isolated from each other.

An example of a known fire safe design today uses four battery stacks. Each battery stack contains three rows of batteries 4 and on each row three batteries 4 are connected in series (FIG. 1). The shelf 31 structure is of aluminium and insulators 32 are mounted between each row. The voltage between each row is approximately a couple of 100 Volts. However, the voltage between the batteries and the floor, walls and roof is the full system voltage and therefore large insulators 30 are mounted between the lowest row of batteries and the floor.

To make it safe for the persons that will make service, a number of design items must be added. In a battery stack material made of aluminium, the aluminium shelves 31, or battery carrying beams, must be voltage potential controlled, so the voltage potential does not float and exceed the insulation level. Therefore, a high ohmic resistor 34 (FIG. 2) is connected between the minus pole 35 of the battery 4 to the aluminium shelf 31 or beam below 31 the battery 4. This is done on each battery row. However, in order to make service, the shelves or beams must be grounded and therefore each balk must be connected to the ground 36 via a disconnector 37. The disconnectors 37 must manage the full DC voltage and are therefore large due to a large needed air distance.

Moreover, the potential control resistor must be disconnected when each shelf or beam is grounded not to discharge the batteries.

### SUMMARY OF THE INVENTION

Accordingly, it is an object of the present invention to provide a simplified battery stacks, still fulfilling space, safety and maintenance requirements for battery backup systems. The system in accordance with the invention should also fulfil the high voltage and high power requirements needed for an adequate VAr compensation.

For this purpose the invention provides a cassette for a battery stack. The cassette comprises a casing for a battery pack made of a plastic or other non-conducting material.

The casing has a front side with an opening for receiving the battery pack.

The casing has a back side, opposite the front side, and the back side is provided with electrical connectors leading into the casing and arranged to connect to the poles of a battery pack when a battery pack is inserted into the casing. Thus, providing an electrical connector at the back side facing away from the front side into which batteries are loaded and out of which battery packs are withdrawn. An operator loading or unloading batteries in a stack of cassettes will be standing in front of the stack and will, thus, be separated from the electrical connectors at the back side by the non-conducting casings.

The electrical connectors in the back side of the casing, from the positive and negative battery pole, respectively, are preferably arranged horizontally separated. In this way stacked battery packs can easily be connected in parallel by a straight connector covering and connecting to each positive connection when the battery packs are placed on top of each other.

Preferably, the battery pack comprises a switch for selectively connecting and disconnecting the battery pack from the electrical connections. In this way a malfunctioning battery pack can be disconnected without removing the battery pack manually.

The cassette is preferably made as a stackable unit, adapted for stacking with identical units.

Preferably, the casing of each unit having an upper surface with first connection means of a two-part mechanical connection, and the casing of each unit having a lower surface provided with second connection means for the two-part connection, each casing thus being adapted for mating with an identical casing in a stack.

Preferably, the casing of each cassette having side surfaces comprising connection means for two part connections of cassettes side by side.

The casing is preferably made of flame retardant material and preferably also being heat insulating.

Preferably the casing comprising ventilation holes allowing air and gas flow into and out of the casing, the ventilation holes being provided in an upper portion of the casing.

Preferably the casing of each cassette comprises connectors for pipes for providing ventilation and cooling of the battery pack.

### BRIEF DESCRIPTION OF THE DRAWINGS

FIG. 1 is a perspective view of a battery stack.

FIG. 2 is a schematic view of a battery stack.

FIG. 3 shows front and back perspective views of a cassette according to one embodiment of the present invention.

FIG. 4 is a perspective view of a cassette according to the present invention.

FIG. 5 is a perspective view of a stack of cassettes according to the present invention.

FIG. 6 is a back view of a portion of the stack of cassettes shown in FIG. 5.

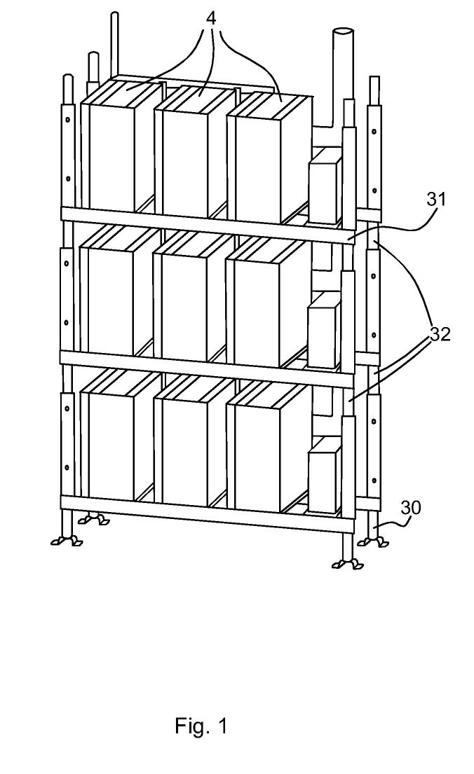

### DETAILED DESCRIPTION OF THE INVENTION

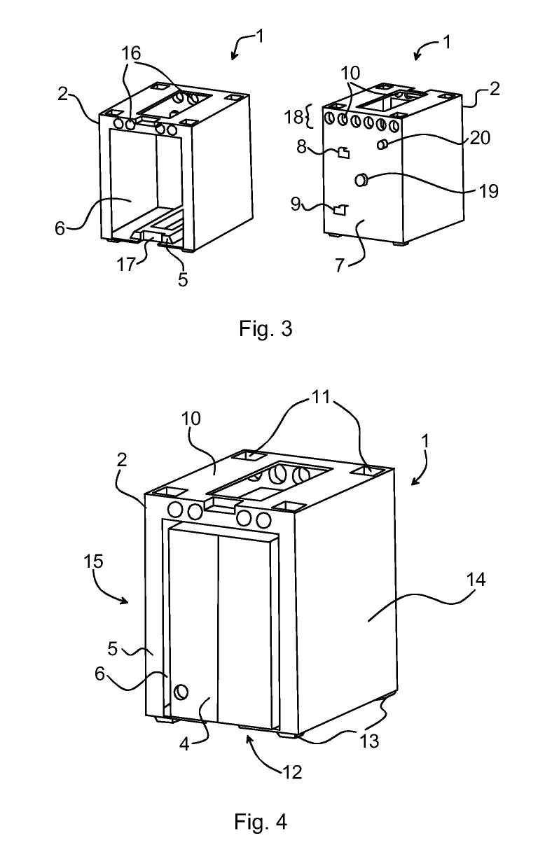

A cassette 1, in accordance with the invention, for a battery 4, also denoted battery pack is illustrated in FIG. 3. The cassette comprises a casing 2 which is made of an electrically isolating or insulating material, such as a plastic or composite material, and has an open front face 5 for receiving a battery. The bottom internal surface of the casing is provided with guides 17 for a controlled insertion of a battery into the interior of the casing.

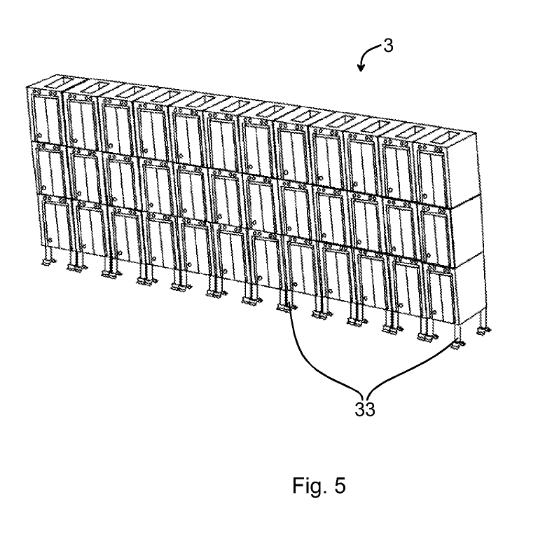

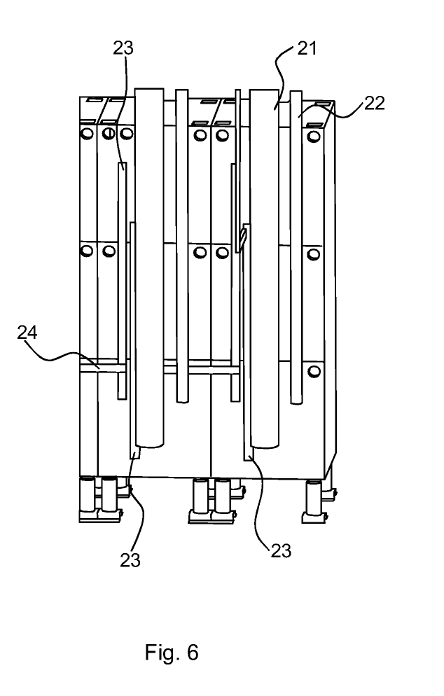

The casing has walls surrounding the battery, a bottom 12, a top 10, and side walls 14, 15. The back 7 of the casing comprises a wall having connectors 8, 9 connected to the poles of an inserted battery. The connectors 8, 9 are separated horizontally from each other, so that a vertical straight connecting bar (23 in FIG. 6) can be vertically arranged connecting the positive poles and negative poles, respectively, of a stack of batteries together. All the walls 7, 10, 12, 14, 15 of the casing is made of the same isolating material, and only the back wall 7 is provided with electrical terminals 8, 9, which terminals are adapted for connection to a bus bar (23, 24 in FIG. 5). Thus, the front 5 provides an opening 6 facing an operator when handling the battery (4 in FIG. 4), whereas the back side 7 that faces away from the operator comprises the poles 8, 9 connected to a bus bar. In this way the operator can safely remove and insert a battery safely isolated from the bus bar by the cassette 1. At the top of the cassette 1, both the front and back surface is provided with ventilation holes 16, the ventilation holes 16 being provided in an upper portion 18 of the casing. Also, pipe connectors 19, 20 for supplying cooling air (19) and ventilating gas (20) are provided in the back side. The casing can alternatively be provided with pipe connections for cooling liquid, such as deionized water, and the cassette adapted for liquid cooling of the battery.

FIG. 4 illustrates a battery 4 inserted inside the cassette 1. The front opening 6 of the cassette 1 is adapted to the size of the battery 4 so that a battery fits neatly with only a small gap preventing erroneous insertion of the battery, and together with the bottom guide (17) guarantees a correct insertion and subsequent connection of the poles of the battery. The top surface of the cassette 1 includes mechanical connections 11, illustrated as grooves 11, and the bottom surface includes corresponding mechanical connections 13, illustrated as knobs 13, for mating two or more cassettes together on top of each other. Thus, the illustrated cassette 1 includes a connection of Lego® type. Alternatively, other means for mating the cassettes on top of each other in a stack such as dove-tail mating connections can be provided.

FIG. 5 illustrates stacked cassettes with batteries 3 inserted. This figure illustrates the front side with the batteries facing an operator. The stack is arranged on isolating leg supports 33 resting on a floor. An alternative is to arrange the stack of cassettes hanging, for example from the ceiling, on an isolated beam or in a rack.

FIG. 6 illustrates a section of two columns with three rows of the back side of the stack 3 in FIG. 5. Vertical connectors connect the positive terminals of each cassette 1 in a column together.

Similarly, the negative terminals of the cassettes in each column are interconnected by a vertical connector 23. Thus, the batteries in each column are electrically connected. Vertical connectors 23 of two adjacent columns are interconnected by a horizontal bar 24, extending between the connectors from a connector in the first column to the connector of the second column. By arranging the terminals in the back side 7 off-set, preferably both vertically and horizontally, easy connection by a straight copper or aluminium bar can be provided. In this way a battery stack fulfilling the need of power and voltage of the system can be achieved more easily with a combination of serial and parallel connections of the batteries 4 in the rows and columns of the stack 3.

Although, vertical and horizontal bars are preferred, another useful alternative is to utilise cables for interconnecting the electrical connectors of the cassettes.

The cassettes provide an easy to build stack having connectors 23 arranged in the back for connection to bus bars 24. Also the connections to ventilation pipes 21 and cooling pipes 22 are arranged in the back. The stack made of the isolating cassettes provides a protection between an operator and the bus bars 23, 24, and loading of batteries can be performed without risk even if the bus bars are not disconnected from the remainder of the system. Using stackable cassettes instead of shelves also have the advantage that additional columns of batteries easily can be added.

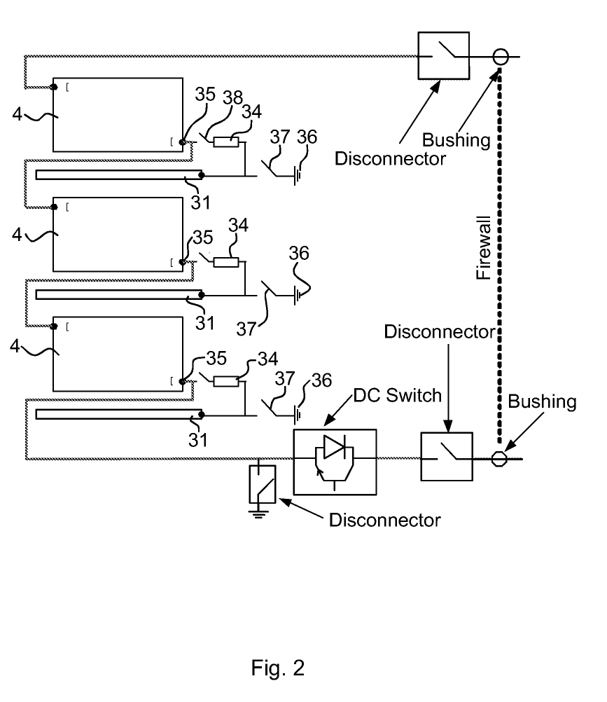

The high ohmic resistor 34, in FIG. 2, between the aluminium beam or shelf 31 and the minus pole 35 of the battery is not necessary since the cassettes does not conduct electricity. For the same reason, the grounding disconnector 37 (of FIG. 2) between the aluminium shelf 31 and ground 36 is not needed. Without the high ohmic resistor 34, the disconnector 38 for this resistor 34 is not needed.

Moreover, even if an operator forgets to connect or disconnect a grounding wire, the operator is protected since there is no electrical conducting aluminium beams or shelves, instead isolating cassette cases.

Thus, modular cassettes 1 for housing batteries 4, including a plurality of cells, especially for VAr compensation, have been provided. Such cassettes 1 can also be used in battery energy storages for providing standby power in the event of a power failure. To provide uninterruptible power a back-up system having a large number of batteries 4 as a power source can be built. The system have the terminals of the individual batteries connected in parallel (by connecting bar 23) and serial connections (by connecting bar 24) to provide the needed voltage and energy for power compensation.

1. A cassette for a battery stack, comprising a casing for a battery pack, the casing having a front side with an opening for receiving the battery pack, and the casing comprises a non-conducting material.

2. The cassette according to claim 1, wherein the casing has a back side, opposite the front side, the back side being provided with electrical connectors leading into the casing and arranged to connect to the poles of a battery pack when a battery pack is inserted into the casing through the front side.

3. The cassette according to claim 2, wherein the electrical connectors in the back side of the casing, from the positive and negative battery pole, respectively, are arranged horizontally separated.

4. The cassette according to claim 1, said cassette being made as a stackable unit, adapted for stacking with similar cassettes.

5. The cassette according to claim 4, wherein the casing comprises a top surface with a first part of a two-part mechanical connection and the casing comprises a bottom surface provided with a second part of the two-part connection.

6. The cassette according to claim 4, wherein the casing of the cassette comprises side surfaces with connection parts for connecting of cassettes side by side.

7. The cassette according to claim 1, wherein the casing comprises a flame retardant material.

8. The cassette according to claim 1, wherein the casing comprises a heat insulating material.

9. The cassette according to claim 1, wherein the casing further comprises ventilation holes allowing air and gas flow into and out of the casing, the ventilation holes being provided in an upper portion of the casing.

10. The cassette according to claim 9, further comprising connectors for pipes for providing ventilating and cooling of a battery pack.

11. (Canceled)

12. The method of claim 22, wherein at least two of said cassettes are placed in mechanical connection on top of each other.

13. The method of claim 22, further comprising the step of electrically connecting the terminals of at least two of the cassettes.

14. The method of claim 13, wherein said step of electrically connecting comprises providing an electrical interconnection being essentially straight and vertical.

15. The method of claim 13, wherein said step of electrically connecting comprises providing an electrical interconnection being essentially straight and horizontal.

16. The method of claim 13, wherein the step of electrically connecting comprises providing at least two electrical interconnections, at least one of which is horizontal and at least one of which is vertical.

17. The method of claim 13, wherein the step of electrically connecting comprises providing an electrically conducting bar or an electrically conducting cable.

18. The method of claim 22, further comprising the step of connecting pipes for ventilating gas to each of the cassettes.

19. The method of claim 22, further comprising the step of connecting pipes for cooling gas to each of the cassettes.

20. The method of claim 22, wherein the step of stacking the further comprises stacking the cassettes in a plurality of rows and a plurality of columns.

21. The method of claim 22, wherein the step of stacking further comprises stacking said cassettes such that said openings for receiving batteries are facing in a forward direction, and said electrical connections arranged on the back are facing in a direction opposite the forward direction.

22. A method for stacking batteries for power compensation in high voltage systems, comprising the steps of:
providing a plurality of modular cassettes, having front openings for the batteries, and back connections for electrical power supply;
stacking said plurality of modular cassettes either side-by-side or top-to-bottom.
